(19) United States
(12) Patent Application Publication
(10) Pub. No.: US 2022/0168861 A1
(43) Pub. Date: Jun. 2, 2022

(54) HOLLOW DRILL DEVICE WITH AN INDICATOR AND METHOD AND SYSTEM FOR DETERMINING AND INDICATING A QUALITY GRADING FOR THE CLEANING OF A DRILLED HOLE

(71) Applicant: Hilti Aktiengesellschaft, Schaan (LI)

(72) Inventor: Oliver OHLENDORF, Landsberg (DE)

(21) Appl. No.: 17/432,336

(22) PCT Filed: Feb. 6, 2020
(86) PCT No.: PCT/EP2020/052959

§ 371 Date: Aug. 19, 2021

(30) Foreign Application Priority Data
Feb. 20, 2019 (EP) 19158177.6

(51) Int. Cl. B23Q 11/00

(52) U.S. Cl. CPC B23Q 11/0046; B23Q 11/0071

(57) ABSTRACT

A hollow drill device for producing a drilled hole includes a suction head, where the hollow drill device is connectable to a dust extraction device by the suction head, a sensor, where a pressure condition in the suction head is determinable by the sensor, and an indicator. A quality grading of a cleaning of a drilled hole is indicatable by the indicator in dependence on a determined pressure condition in the suction head by the sensor.

### BACKGROUND AND SUMMARY OF THE INVENTION

The present invention relates to a hollow drill device for producing a drilled hole, wherein the hollow drill device comprises an indicator, with which a quality grading of the cleaning of a drilled hole can be indicated. The invention also relates to a system which comprises a hollow drill device and an external unit and with which a quality grading of the cleaning of a drilled hole can be indicated. In a further aspect, the invention relates to a method for determining and indicating a quality grading for the cleaning of a drilled hole.

Drilling devices that are suitable for producing drilled holes in sometimes very hard base material, such as for example concrete, are known in the prior art. These drilling devices operate with drilling tools that work themselves into the material to be drilled through and in this way produce the usually round drilled hole. The drilling devices may be equipped with conventional, solid drilling tools. However, hollow drilling tools, which are for example known as “hollow drilling bits”, may also be used. When the tools known as “hollow drilling bits” are used, the broken-down material occurring during the production of the drilled hole may be removed from the drilled hole through openings within the hollow drilling tool, in that it is sucked out of the drilled hole by a negative pressure. The drilling tool or the drilling device connected thereto may for this purpose be connected to a dust extraction device, which produces a negative pressure in a known way. The negative pressure is in this case set such that a sufficiently great extracting volumetric flow is produced to extract the dust and the broken-down material out of the drilled hole.

When conventional, solid drilling tools are used, the operator of the drilling device must take laborious measures after producing the drilled hole to work dust and broken-down material out of the drilled hole. Depending on statutory and other stipulations, these measures are for example that the drilled hole produced must be flushed a number of times with an air stream and/or be wiped out a number of times with a brush. It should be endeavored to obtain an optimally cleaned drilled hole, in order to ensure a good fastening effect or a stable connection between the base material and the fastening material, such as for example a dowel and/or anchor, in the drilled hole produced.

It has been found that the intensity or magnitude of the extracting volumetric flow with which dust and broken-down material is extracted from the drilled hole may depend on various factors, so that in some cases it is difficult for the operator to ascertain whether at every point in time of the operation of the drilling device an optimum cleaning of a drilled hole is achieved by the system comprising the drilling device, drilling tool and dust extraction device. The various factors that may influence the quality of the cleaning of a drilled hole are in particular variable ambient conditions in the area around the drilled hole to be produced, for example the type of dust extraction device used, the type of tube used, the state of the filter and the dust extraction device or the diameter of the hollow drilling tool or the size and number of the openings of the hollow drilling tool. The depth of the drilled hole, the performance class of the extractor used or the extraction cross section may also play a role. In particular, there may be situations in which the operator or the user of the drilling system comprising the drilling device, drilling tool and dust extraction device lacks information to be able to estimate whether adequately good cleaning of a drilled hole is taking place at the particular time. In particular, the great number of factors influencing the operator makes the assessment of the state of the drilled hole with respect to its degree of cleaning difficult for the operator; this is also the case in particular because it is often unclear how the individual factors relate to one another or how they influence one another or interact with one another.

The object of the present invention is therefore to overcome the disadvantages of conventional hollow drill devices described above and to provide a hollow drill device with which the operator can quickly and unlaboriously ascertain in a simple way whether the degree of cleaning of a drilled hole is within an acceptable range and whether no further measures for cleaning the drilled hole have to be taken. It would be particularly desirable if the user could be provided with quickly discernible, objective and resilient feedback on the state of cleaning of a drilled hole, to be precise directly during the production of the drilled hole, that is to say directly when drilling the hole.

The object is achieved by the subject matter of the independent claims. Advantageous embodiments of the subject matter of the independent claims can be found in the dependent claims.

The object is achieved by a hollow drill device for producing a drilled hole, wherein the hollow drill device comprises a suction head for connecting the hollow drill device to a dust extraction device. The hollow drill device is characterized in that it comprises an indicator, wherein the indicator is designed to indicate a quality grading of the cleaning of a drilled hole, wherein the hollow drill device comprises a sensor for determining pressure conditions in the suction head and the indicator indicates the quality grading of the cleaning of a drilled hole in dependence on determined pressure values in the suction head. The invention allows a simple and intuitive indication of the quality of the cleaning of a drilled hole at the particular time and increased reliability of uses of dowels. One particular advantage of the invention is that the operator of the provided hollow drill device is provided in a quick, simple and easily discernible manner with feedback about the quality of the cleaning of a drilled hole produced.

It is preferred in the context of the invention to refer to the provided indicator as a “negative-pressure-controlled indicator”, since the indication of the different quality gradings of the cleaning of a drilled hole takes place in dependence on the pressure conditions within the suction head of the hollow drill device. The term “pressure conditions” in the context of the invention preferably refers to the pressure that prevails in the suction head during operation of the hollow drill device. This is in particular a negative pressure, since the dust extraction device preferably uses negative pressure to suck up dust and contaminants, in order to suck the dust through the suction tube into the interior of the dust extraction device. The term “negative pressure” refers in particular to such a pressure that is lower than the usual atmospheric pressure or the pressure of the surroundings in which the hollow drill device is operated. To this extent, it is particularly preferred in the context of the invention that the indicator indicates the grading of the cleaning of a drilled hole in dependence on determined negative pressure values in the suction head.

It is particularly preferred in the context that the hollow drill device comprises the sensor for determining the pressure conditions in the hollow drill device in particular in the region of the suction head, or that the sensor is arranged in the spatial proximity of the suction head of the hollow drill device. In a preferred embodiment of the invention, the indicator for the quality of the cleaning of a drilled hole is arranged on the suction head. The arrangement of the indicator on an upper side of the suction head is particularly advantageous, because the indicator thereby lies directly in the field of view of the operator of the hollow drill device and can be kept in view by the operator without turning his head away from the drilled hole. In particular, optimum visibility during the drilling operation is achieved by the provided arrangement of the indicator device. The sensor may preferably be an electronic pressure sensor. The pressure sensor is preferably designed to transmit the determined pressure conditions or the quality data for the cleaning of a drilled hole derived therefrom to the indicator of the hollow drill device. If the hollow drill device interacts with an external unit, such as a mobile communication device, it may also be preferred that the determined pressure conditions or the quality data for the cleaning of a drilled hole derived therefrom are transmitted to the external unit by using the preferably electronic pressure sensor. The data acquired can then be indicated by an indicator device of the external receiver unit. Preferably, the data transmission between the hollow drill device and the external unit forms a communication link, which is preferably a component part of the system comprising the hollow drill device and the external unit. This communication link preferably operates by using the preferably electronic pressure sensor.

It may also be preferred in the context of the invention that the preferably visual indicator device is formed in the region or as a component part of the extracting element. The present invention is based on the realization that the quality of the cleaning of a drilled hole, which is also preferably referred to in the context of the invention as the efficiency of the cleaning of a drilled hole, has to do with the pressure conditions in the suction head of the hollow drill device. The appreciation of this correlation advantageously makes it possible to determine the pressure within the suction head by a sensor and to use the pressure values thus determined for determining the quality of the cleaning of a drilled hole. It is particularly preferred in the context of the invention to refer to the invention as a visual indication of the efficiency of the cleaning of a drilled hole.

In particular, it has been realized in the context of the invention that the static pressure in the suction head is essentially directly proportional to an extracting volumetric flow. The term “extracting volumetric flow” preferably refers in the context of the invention to that air stream with which dust can be extracted from a drilled hole by using negative pressure when a hollow drilling tool is used when drilling. Such a hollow drilling tool may preferably be equipped with openings in its front region, where the contact with the material to be drilled through takes place, wherein a negative pressure can be applied to these openings by a dust extraction device. The negative pressure has the effect that the dust created during the drilling is sucked through the openings into the hollow drilling tool and transported through the tool, the suction head and the extracting tube into the interior of the dust extraction device, where it is kept in a collecting container. The term “essentially proportional” is a term that is not unclear to a person skilled in the art, because a person skilled in the art knows that there is no strict proportionality in the sense of a constant proportionality factor that remains the same for all pairs of values, but rather a correlation in which the relationship between the determined negative pressure and the extracting volumetric flow essentially assumes a linear progression, wherein the slope of the line can assume different values within a certain range for different pairs in terms of pressure and volume.

It is preferred in the context of the invention that a particularly low-cost element, for example a tube with a spring, can be used for realizing the invention. The tube may for example be designed as a preferably elastic membrane, wherein the preferably elastic membrane can be deflected by the pressure difference in the suction head, depending on the magnitude of the pressure difference. Preferably, a deflection excursion of the membrane is determined by the determined pressure values in the suction head, wherein the deflection excursion of the membrane can be advantageously used to indicate the preferably colored pressure stages or the quality grading for the cleaning of a drilled hole. In other words, the deflection of the preferably elastic membrane is preferably dictated by the pressure conditions, in particular the pressure differences or the extracting volumetric flow in the suction head.

It has been realized in the context of the present invention that the extracting volumetric flow preferably determines the quality of the extraction in the region of the wall of the drilled hole. In particular, it has been found that a higher extracting volumetric flow leads to improved cleaning of the wall of the drilled hole. A significant advantage of the invention is that, with the provided indicator, the operator of the hollow drill device is provided with feedback from the provided device as to whether the cleaning of a drilled hole during the drilling is adequate to be able to do without further measures for cleaning the drilled hole after its completion. An optimally cleaned drilled hole leads to higher dowel pulling-out forces, so that improved fastening quality can be achieved if adequately clean drilled holes are used to receive fastening mortar or the basic compound for a chemical dowel. Consequently, the invention advantageously increases the reliability of the fastening produced with the drilled hole and of the building constructed with it. Furthermore, the stability of the fastening can be effectively increased by using the invention.

It is preferred in the context of the invention that the hollow drill device comprises means in order that the pressure values determined in the suction head are transmitted to the indicator. The transmission of these data may take place in a wireless or wire-bound manner. For example, the data may be transmitted from the pressure sensor to the indicator device by a data cable within the device. However, it may also be preferred for some applications that wireless communication means are used for the data transmission. Preferably, the hollow drill device comprises means for evaluating the pressure values determined in the suction head. This may be for example a processor, microprocessor or other evaluation unit, which is preferably designed to assign the determined pressure values to an extracting volumetric flow and to derive therefrom an extraction quality or an efficiency of the cleaning of a drilled hole. This may take place for example in that the determined pressure values and/or the determined value for the extracting volumetric flow are compared with predefined reference values, which may for example be stored in a database. For example, individual value ranges may be assigned different quality gradings, such as “good”, “adequate” and “action required”. These different quality gradings may be indicated by the indicator, for example by using a traffic-light system of colors. In other words, it is most particularly preferred that different quality gradings of the cleaning of a drilled hole are indicated by different colors.

It is preferred in the context of the invention that the indicator is an optical indicator. Preferably, the quality grading “good” for the cleaning of a drilled hole is indicated by the color “green”, while for example the quality grading “adequate” is indicated by the color “yellow”, and the quality grading “action required” is indicated by the color red. The indicator may for example also be designed such that two different quality gradings for the cleaning of a drilled hole differ and are indicated. For example, a first quality grading may be that the efficiency of the cleaning of a drilled hole meets the requirements for satisfactory cleaning of the drilled hole, wherein the state could be identified for example by emission of a green color signal. A second quality grading may for example be that the requirements for adequate cleaning of a drilled hole are not met. This second quality grading may for example be indicated by a color signal kept in the signal color red. The second quality grading of “red” may for example also indicate or mean that the hollow hole drill is clogged. Preferably, the use of the color “red” should be understood in the context of the present invention as meaning that the user is shown that the cleaning of a drilled hole is not optimum and that there is a need for action. In this embodiment of the invention with two different quality gradings for the cleaning of a drilled hole, the indicator device may in particular be referred to as a “binary indicator”. It is in particular preferred in the context of the invention that the indicator device changes its color if for example the negative pressure goes below a previously set or predefined level. To this extent, the indicated color preferably correlates with the determined pressure values and/or the extracting volumetric flow values derived therefrom, which in the context of the present invention is referred to as indication of the quality of the cleaning of a drilled hole “in dependence on determined pressure values”.

It is particularly preferred in the context of the invention that the indicator is arranged directly in the field of view of the operator of the hollow drill device, in order that the operator can have the indicator in view during work. In particular, the operator does not have to avert attention from the drilled hole if he wishes to ascertain the indication and at the same time operate the hollow drill device. It is preferred in the context of the invention that the indicator device has a small size, so that it advantageously does not distract the operator from his work or obscure his view. It is particularly preferred in the context of the invention that the negative-pressure-controlled indicator device is arranged or placed in or on a suction head of the hollow drill extractor. The invention can advantageously provide user support, with which the reliability and stability of a connection between a chemical anchor and a drilled hole can be improved, in that the operator of the hollow drill device can simply ascertain at every point in time of the operation of the device whether or not the cleaning of a drilled hole during the drilling is adequately good. In particular, the invention allows monitoring of the cleaning of a drilled hole, for example if the pressure values determined with the sensor or the data evaluated with the evaluation unit for the extracting volumetric flow are stored. The data can then be read out at a later point in time and/or be used for purposes of documentation.

The provided invention also relates in particular to the indicator device, wherein the indicator device may for example be fitted on a suction head of a hollow drill device. This indicator device may preferably also be referred to as a control indicator. It is most particularly preferred in the context of the invention that the indicator may indicate, for example by a color, that the cleaning of a drilled hole is inadequate. In this case, the operator would have to carry out measures after the drilling of the hole that are required when using a conventional drilling device without a hollow drilling tool in order to clean the drilled hole and prepare it for further fastening work. These measures are in particular that of flushing the drilled hole produced a number of times with an air stream and wiping it out with a brush.

For indicating the different quality gradings, the indicator may for example comprise lighting means, wherein the lighting means are designed to emit light in different colors, i.e., at different wavelengths or frequencies. For this purpose, the indicator device may either comprise a lighting means that emits “white” light which is colored by various filters. It may alternatively also be preferred that the indicator comprises various lighting means that emit light in different colors. In a particular configuration of the invention, the indicator may also be designed to flash at intervals, wherein for example different flashing frequencies may identify different quality gradings of the cleaning of a drilled hole.

In a second aspect, the invention relates to a system which comprises a hollow drill device and a mobile communication device as an external unit. The mobile communication device may be a smartphone or cell phone, a notebook, a laptop, a handheld device, a tablet or the like, without being restricted thereto. In particular, the mobile communication device comprises an indicator device, such as for example a screen, a touch screen, a monitor or a display, wherein the mobile communication device is designed to take over the indicating function of the indicator of the provided hollow drill device. For this purpose, the pressure values determined in the suction head may be transmitted by a wireless or wired-bound communication device to the mobile communication device. In particular, a wireless communication link, for example based on Bluetooth or WIFI/WLAN, is preferred. In other words, it is preferred in the context of the invention that the system comprises a communication link between the hollow drill device and the at least one external unit. Preferably, the communication link is designed to transmit the pressure values determined by the sensor of the hollow drill device or the quality gradings for the cleaning of a drilled hole derived therefrom to the at least one external unit, so that these data can be presented by the external unit by using an indicator device. For example, the quality of the cleaning of a drilled hole at the particular time may be indicated on the mobile communication device in the form of an app. For this purpose, the app may comprise corresponding operating and/or indicating interfaces. An indication of the determined pressure values or of the efficiency of the cleaning of a drilled hole derived therefrom on the dust extraction device may also be provided in the context of the present invention. In particular, the invention relates in this aspect of the invention to a system comprising a hollow drill device with a suction head and an external unit, wherein the external unit comprises an indicator, wherein the indicator is designed to indicate a quality grading of the cleaning of a drilled hole, wherein the hollow drill device comprises a sensor for determining pressure conditions in the suction head and the indicator indicates the quality grading of the cleaning of a drilled hole in dependence on determined pressure values in the suction head. The external unit - for example a smartphone or a cell phone—may be set up or arranged with respect to the operator of the hollow drill device such that the operator has its indicator device well within view while the hollow drill device is in operation. Thus, the operator of the hollow drill device always has a good view of the quality of the cleaning of a drilled hole and, if required, can take appropriate measures. In the case of the mobile communication device, the external may preferably also be formed by the dust extraction device itself. For this purpose, the dust extraction device preferably has an indicator device and is preferably designed to indicate the quality grading of the cleaning of a drilled hole.

In a further aspect, the invention relates to a method for determining and indicating a quality grading for the cleaning of a drilled hole, wherein the method comprises the following steps:

a) providing a hollow drill device, wherein the hollow drill device comprises a sensor for determining a pressure in a suction head,

b) measuring the pressure within the suction head,

c) indicating a quality grading of the cleaning of a drilled hole by an indicator.

The terms, definitions and technical advantages introduced for the hollow drill device apply analogously to the provided method for determining and indicating a quality grading for the cleaning of a drilled hole. Preferably, the sensor is arranged in particular in the suction head of the hollow drill device. The sensor is preferably a pressure sensor, which may preferably be an electronic pressure sensor. The pressure that is determined by the sensor is preferably a negative pressure, which is used for sucking in the broken-down drilled material or dust. After the measuring of the pressure values, they are preferably transmitted to the indicator, wherein for example wireless or wired-bound communication or data transmission means may be used. In particular, the measuring of the pressure and also the indication of the derived quality gradings of the cleaning of a drilled hole take place during the operation of the hollow drilling device, wherein the indicated quality gradings are respectively adapted to the measured values and/or evaluation results at the particular time. As a result, it is advantageously achieved that the operator is always optimally informed with regard to the quality of the cleaning of a drilled hole achieved at the particular time. The provided method may also comprise the evaluation of the pressure values determined in the suction head, wherein this evaluation may for example be performed by an evaluation unit. Preferably, a quality grading for the cleaning of a drilled hole may also be derived or determined by the evaluation of the measured pressure values.

The indicator may be a component part of the hollow drill device or be arranged externally. The expression “external arrangement” comprises for example the indication of the determined pressure values or the indication of the efficiency of the cleaning of a drilled hole derived therefrom on a mobile communication device or on an indicator device of an external unit. For example, the quality of the cleaning of a drilled hole may be indicated on an operating and/or indicating interface of an app that is operated on a smartphone or cell phone. An indication of the determined pressure values or of the quality of the cleaning of a drilled hole derived therefrom on the dust extraction device may also be provided in the context of the invention. For this purpose, the dust extraction device comprises a suitable indicator device. Preferably, the determined pressure values or the efficiency data of the cleaning of a drilled hole derived therefrom may be transmitted by a communication link between the hollow drill device and the external unit.

Further advantages will become apparent from the following description of the figures. The figures, the description and the claims contain numerous features in combination. A person skilled in the art will expediently also consider the features individually and combine them to form expedient further combinations.

In the figures, identical components and components of identical type are designated by the same reference signs.

### BRIEF DESCRIPTION OF THE DRAWINGS

FIG. 1 shows a view of a preferred configuration of the invention, in particular of a provided hollow drill device; and

FIG. 2 shows a view of a preferred configuration of the invention, in particular of a provided system.

### DETAILED DESCRIPTION OF THE DRAWINGS

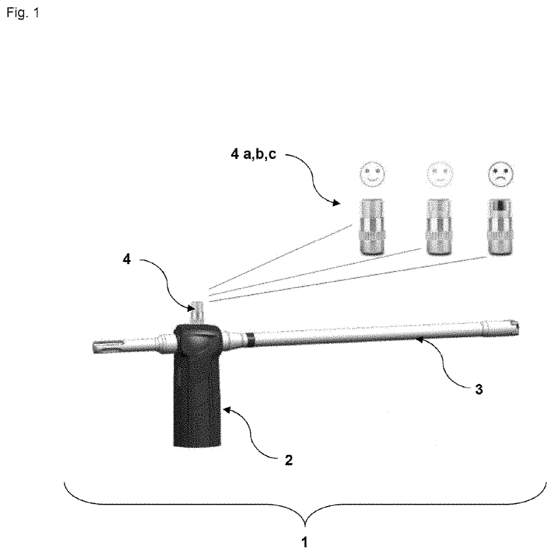

FIG. 1 shows a preferred configuration of a provided hollow drill device (1). Shown is a drilling tool (3), which may in particular be a “hollow drill bit”. The drilling tool (3) is connected to a suction head (2), which in turn can be connected to a dust extraction device. Dust and contaminants can be sucked out of the drilled hole through the hollow drilling tool (3) by the dust extraction device. The essence of the present invention is an indicator (4), which may for example be arranged in the region of the suction head (2) on the hollow drill device (1). In the exemplary embodiment of the invention that is shown in FIG. 1, the indicator device (4) is arranged on a top or upper side of the suction head (2), in order that the indicator (4) can be kept in view as easily as possible by the operator of the hollow drill device (1) while the operator is drilling a hole with the hollow drill device (1). In other words, in the exemplary embodiment of FIG. 1, the indicator (4) is in the field of view of the operator.

The indicator (4) in FIG. 1 is designed as an optical indicator, wherein different colors preferably stand for different quality gradings of the cleaning of a drilled hole. For example, a green indication (4a, on the left in the figure) may stand for adequate cleaning of a drilled hole, in the case of which no additional cleaning measures are required for the drilled hole and, even without these measures, a good connection between the fastening system and the drilled hole can be expected. A red indication (4c, on the right in the figure) may for example stand for inadequate cleaning of a drilled hole, in the case of which further measures for improved cleaning of the drilled hole or measures against a possibly clogged hollow drill must be carried out, in order to ensure that for example a chemical dowel can be anchored well in the drilled hole. A yellow indication (4b, in the middle of the figure) may for example stand for a critical or possibly inadequate cleaning of a drilled hole. It may in particular also be the case that a yellow indication (4b) indicates a change from good cleaning of a drilled hole to poor cleaning of a drilled hole, or vice versa. In this way, the operator of the hollow drill device (1) can acquire knowledge of possible changes in the ambient conditions and factors that influence the quality of the cleaning of a drilled hole, and possibly take remedial action.

It may however also be preferred in the context of the invention that the indicator (4) is arranged at another location of the suction head (2). For example, the indicator (4) may also be formed as a display screen, which is for example arranged on one of the side surfaces of the suction head (2). It may also be preferred in the context of the invention that the indicator (4) is formed as an optical indicator (4) and for example emits a single-colored flashing light, wherein different flashing frequencies stand for different efficiencies of the cleaning of a drilled hole.

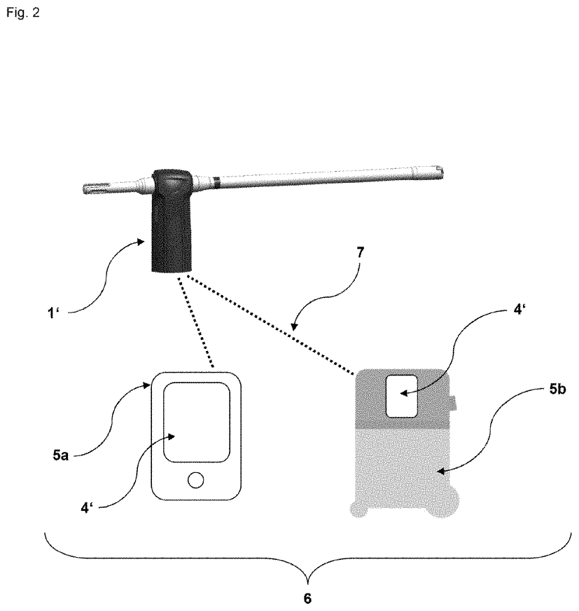

FIG. 2 shows a view of a preferred configuration of the invention, in particular of a provided system (6). The system (6) comprises a hollow drill device (1′), wherein the reference sign 1′ means that a hollow drill device (1′) of the system (6) does not itself have to comprise an indicator device (4). Like the provided hollow drill device (1), the hollow drill device (1′) comprises a suction head (2), which comprises sensors for determining pressure conditions in the suction head (2). The system (6) also comprises at least one external unit (5). The exemplary embodiment of the system (6) that is shown in FIG. 2 shows two external units (5), wherein a first external unit (5a) is formed by a mobile communication device and a second external unit (5b) is formed by the dust extraction device with which the hollow drill device (1 or 1′) interacts. In the context of the provided system (6), the indication of the determined pressure conditions in the suction head (2) preferably takes place on an indicator device (4′), wherein the reference sign 4′ indicates that it is an indicator device of an external unit (5). For example, an indicator device (4′) may be arranged on an upper side of the dust extraction device (5b) to which the hollow drill device (1′) is connected.

Between the hollow drill device (1′) and the external units (5) there is preferably a communication link (7), which in a particularly preferred configuration of the invention is wirelessly configured. It is most particularly preferred in the context of the invention that the communication link (7) is a Bluetooth and/or a WIFI/WLAN link.

### LIST OF REFERENCE CHARACTERS

1 Hollow drill device
2 Suction head
3 Drilling tool
4 Indicator
5 External unit
6 System
7 Communication link

1.-8. (canceled)

9. A hollow drill device for producing a drilled hole, comprising:
a suction head, wherein the hollow drill device is connectable to a dust extraction device by the suction head;
a sensor, wherein a pressure condition in the suction head is determinable by the sensor; and
an indicator, wherein a quality grading of a cleaning of a drilled hole is indicatable by the indicator in dependence on a determined pressure condition in the suction head by the sensor.

10. The hollow drill device as claimed in claim 9, wherein the indicator is disposed on an upper side of the suction head.

11. The hollow drill device as claimed in claim 9, wherein the indicator is an optical indicator.

12. The hollow drill device as claimed in claim 9, wherein different quality gradings of the cleaning of the drilled hole are indicated by respective different colors.

13. A system, comprising:
a hollow drill device with a suction head and a sensor, wherein a pressure condition in the suction head is determinable by the sensor; and
an external unit, wherein the external unit includes an indicator and wherein a quality grading of a cleaning of a drilled hole is indicatable by the indicator in dependence on a determined pressure condition in the suction head by the sensor.

14. A method for indicating a quality grading of a cleaning of a drilled hole, comprising the steps of:
providing a hollow drill device with a suction head and a sensor;
determining a pressure condition in the suction head by the sensor; and
indicating the quality grading of the cleaning of the drilled hole by an indicator in dependence on the determined pressure condition in the suction head by the sensor.

15. The method as claimed in claim 14, wherein the indicator is a component part of the hollow drill device.

16. The method as claimed in claim 14, wherein the indicator is a component part of an external unit.
